(19) United States
(12) Patent Application Publication
(10) Pub. No.: US 2002/0001990 A1
(43) Pub. Date: Jan. 3, 2002

(54) Electrical-cord retainer

(76) Inventor: William G. Ellis, Toluca Lake, CA (US)

Correspondence Address: ALBERT O COTA, 5460 WHITE OAK AVE, SUITE A-331, ENCINO, CA, 91316, US

(21) Appl. No.: 09/801,249

(22) Filed: Mar. 7, 2001

Related U.S. Application Data
(60) Provisional application No. 60/189,295, filed on Mar. 10, 2000.

(51) Int. Cl. H01R 13/62

(52) U.S. Cl. 439/373

(57) ABSTRACT

An electrical-cord retainer (10) designed to function in combination with an electrical or electronic receptacle (68), an electrical cord (60) and a wallplate (82). The retainer (10) is comprised of a integral structure consisting of a base (12) having a perimeter channel (22) which surrounds the base (12). The base includes a centered opening (16) into which is located and attached the electrical receptacle (68). The channel (22) includes a set of cord retaining slots (38) that are preferably located at 0°, 90°, 180°, and 270°. The retainer (10) functions by allowing the access electrical cord (60) to be wrapped around the perimeter channel (22). When a practical length of cord is reached the cord (60) is slipped into the closest cord retaining slot (38) prior to the plug end of the cord (60) being inserted into the electrical or electronic receptacle (68).

### TECHNICAL FIELD

The invention pertains to the general field of electrical receptacles and electrical cords and more particularly to an electrical receptacle located within an electrical-cord retainer which allows access electrical cord to be wrapped around the retainer prior to plugging the cord plug into the receptacle.

### BACKGROUND ART

There are two means by which electrically-powered devices can be supplied with power. The first is by use of a battery and the second is by plugging the device into a utility-power electrical receptacle located on walls throughout a structure.

Depending on what device is being used, a manufacturer will try to determine the necessary cord length, with one end of the cord attached to the device, and the other end attached to a plug. Some devices, such as vacuum cleaners, require substantially long cords, so as to facilitate the vacuum's movement throughout a room. Other devices, such as radios, have shorter cords, since it is anticipated that the radio will be placed close to an outlet.

Unfortunately, people often have other plans for the placement of their electrically-powered devices. Apparently, the manufacturers decided that it is better to provide the consumer with a longer cord than is necessary, as opposed to a cord that is too short. Some manufacturers do provide other means of varying cord length; the most popular is having a long length of cord that can extend out from, or retract into, the device. The use of these types of cords are limited though by space considerations—the device must have enough room to store a completely retracted cord. The most common use for these cords is on vacuum cleaners; it is simply not feasible to use them on most other devices.

As a result, there is usually a substantial amount of cord left in the way after a device is plugged in. In addition to being unsightly, the cords can become safety hazards, especially when left haphazard on the floor or ground. Obviously, it would be very beneficial to have a means by which excess power cord could be placed out of way in a safe and aesthetic manner.

A search of, the prior art did not disclose any patents that read directly on the claims of the instant invention however, the following U.S. patents were considered related:

| U.S. PAT. NO. | INVENTOR | ISSUED |
|---|---|---|
| 5,934,919 | Cross, et al | August 10, 1999 |
| 5,110,303 | Hardy | May 5, 1992 |

The 5,934,919 patent discloses a system for retaining a plug carried by a cord in a socket of an electrical receptacle. The system includes a plate mountable to the receptacle. The plate has opposed lugs on each side of the socket. The lugs form opposed slots to receive flanges formed on one end of resilient arms of a retainer. A retention device is formed near the other end of the arms to hold the cord. Deflectable tines are received in the opposed slots and shoulders extend from the top of the cover plate to engage a top edge of the lugs. In a second embodiment, a gap may be provided to separate each lug so that the system may be employed to cover just a single socket.

The 5,110,303 patent discloses an electrical cord retainer apparatus adapted for securing the interconnection of two or more electrical cords. The retainer includes a flexible housing fitted with a longitudinally non-stretchable retainer strip. The housing is adapted to be encased about a connection of electrical power cords and to provide a high coefficient of friction fit between the interior of the housing and the electrical cord plugs sufficient to retain those plugs in intercooperation notwithstanding the application of forces to the cords at a distant location. The housing is fitted with a connection structure such as a zipper which is adapted to close the housing about the structure of electrical cord for purposes of creating this friction union.

### DISCLOSURE OF THE INVENTION

The electrical-cord retainer is designed to be used in combination with an electrical receptacle and an electrical cord. The cord can consist of a utility power cord that terminates with a plug or cords that are used with various electronic equipments that terminate with a specialized connector.

The basic design of the electrical-cord retainer is comprised of a molded integral unit consisting of a base that is surrounded by a perimeter channel. The channel boundary can be configured in various geometric designs such as a rectangle or a circle. The circle design is particularly suitable for commercial use where long lengths of cord are often used.

The base includes a means for attaching the electrical receptacle to the base. The means consists of an opening substantially centered on the base. Near the upper and lower edges of the opening is located a bore which is in alignment with a pair of receptacle mounting bores located on a pair of tabs extending from the upper and lower ends of the electrical receptacle. When a threaded bolt is inserted through each of the bore pairs the electrical receptacle is attached to the bore. When the bolt is further threaded into a pair of respective bores located on a junction box embedded within a wall structure, the electrical-cord retainer is attached to the wall. To complete the attachment of the retainer, a conventional wallplate having a centered bore is used. To attach the wallplate a threaded bolt is inserted through the wallplate and into a centered bore located on the electrical Receptacle.

The perimeter channel includes on its upper and side surfaces a plurality of cord retaining slots that can be randomly located. However, the slots are preferably located at 0°, 90°, 180° and 270° as referenced from a centered vertical line.

To utilize the electrical-cord retainer the excess portion of the electrical cord extending from an electrical appliance or an electronic unit is initially wrapped around the interior of the perimeter channel. When a practical, minimum cord length is reached, the cord is inserted into the nearest cord retaining slot, from the slot the cord is then inserted into the electrical receptacle.

In view of the above disclosure it is the primary object of the invention to provide an electrical-cord retainer which allows access cord to be wrapped around the electrical-cord retainer prior to being plugged into a wall receptacle.

In addition to the preferred object of the invention it is also an object of the invention to produce an electrical-cord retainer that:

can be produced in various colors to accent or compliment the decor of the room,

can be made in various geometric shapes and sizes to accommodate various types and lengths of electrical/electronic cords,

can be designed to fit various designs and types of receptacles and wallplates,

provides a safety factor in that excess cord is eliminated,

eliminates clutter and projects a neater, more aesthetic appearance,

is cost-effective from a manufacturing and consumer points of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a perspective view of a rectangular electrical-cord retainer having a base with an opening dimensioned to accommodate a duplex utility power receptacle shown with a wallplate attached.

FIG. 2 is a front elevational view of the electrical-cord retainer having a base with an opening dimensioned to accommodate a flush-mount utility-power receptacle shown attached without a wallplate.

FIG. 3 is a side elevational view of an electrical-plug retainer which has a perimeter channel having a rediused upper center section.

FIG. 4 is a side elevational view of an electrical-cord retainer which has a perimeter channel having a substantially square upper center section.

FIG. 5 is an elevational front view of circular electrical-cord retainer shown with an electrical cord wrapped around the perimeter channel, the cord inserted into one of the cord retaining slots and with the electrical cord plug inserted into an electrical receptacle.

### BEST MODE FOR CARRYING OUT THE INVENTION

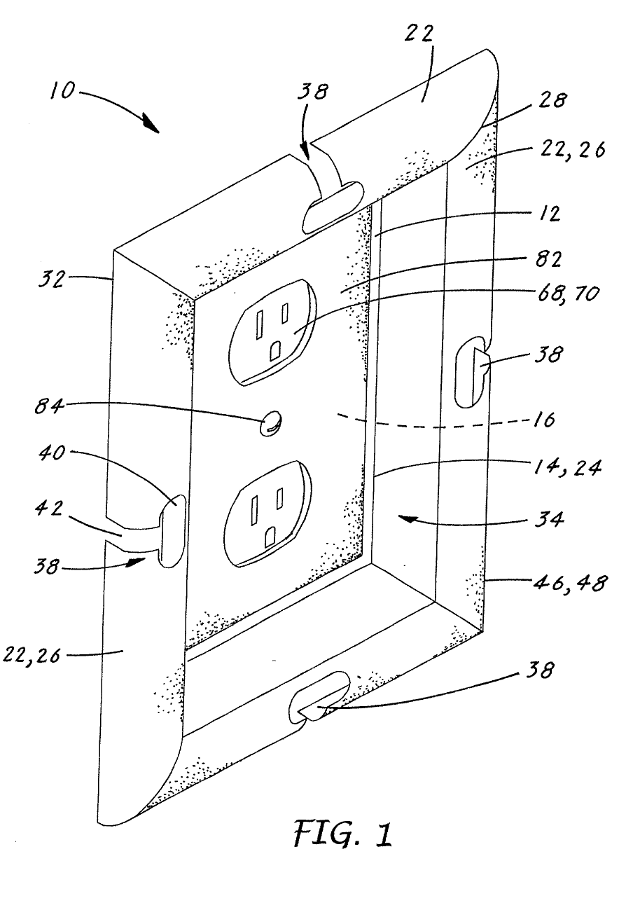

The best mode for carrying out the invention is presented in terms of a preferred embodiment for an electrical-cord retainer which functions by allowing access electrical cord from an electrical appliance or an electronic unit to be wrapped around the retainer prior to attaching the cord plug into a power receptacle. The preferred embodiment, as shown in FIGS. 1-5, is presented in terms of two design configurations: a square electrical-cord retainer and a circular electrical-cord retainer. Both designs of the retainer 10 are comprised of a single structure consisting of a base 12 having integrally attached a perimeter channel 22.

The electrical-cord retainer 10 is designed to be used in combination with an electrical cord 60, an electrical receptacle 68 and preferably a receptacle wallplate 82.

Note that the reference to an electrical cord is intended to be generic to a utility power cord, which terminates with a utility power plug 62, an electronic equipment cord which terminates with an electronic equipment connector 66, a telephone cord or the like.

The electrical-cord retainer 10 is integrally molded preferably by an injection molding process of a plastic such as acrylic, phenolic, polyethylene or polyvinylchloride (FPVC). The plastic retainer can also be produced in a variety of colors and finishes and may include various indicia to enhance the aesthetics of the retainer. Additionally, the retainer can be produced in a transparent or translucent plastic to allow the finish of the wall, to which the retainer is attached, to be visible through the retainer 10.

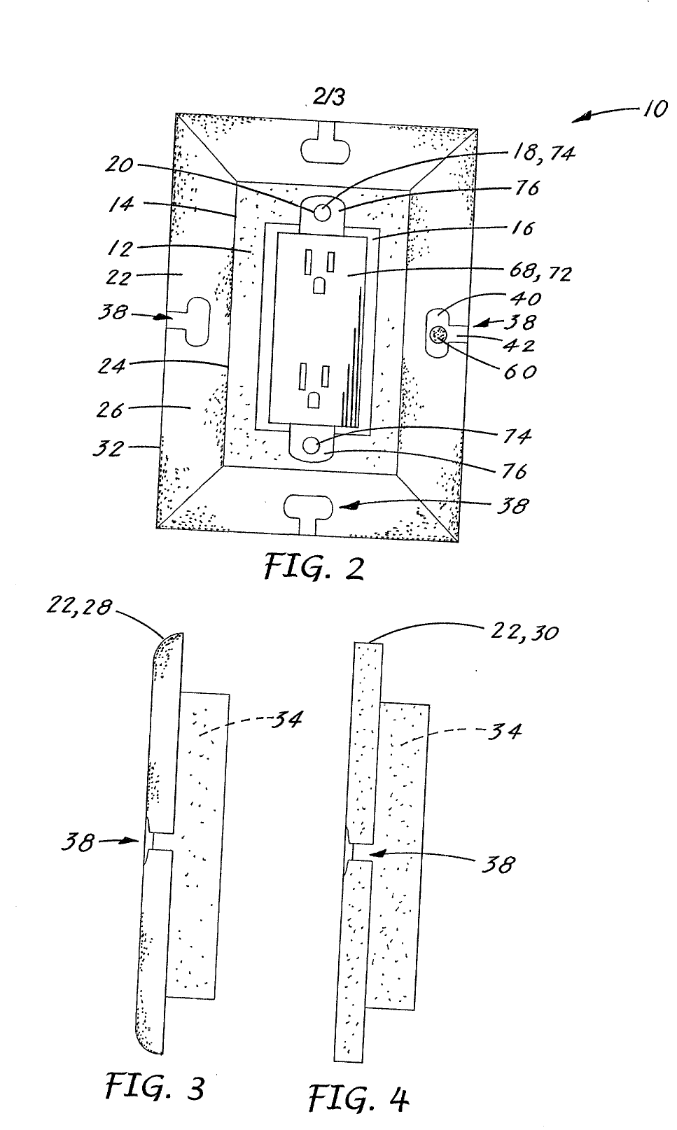

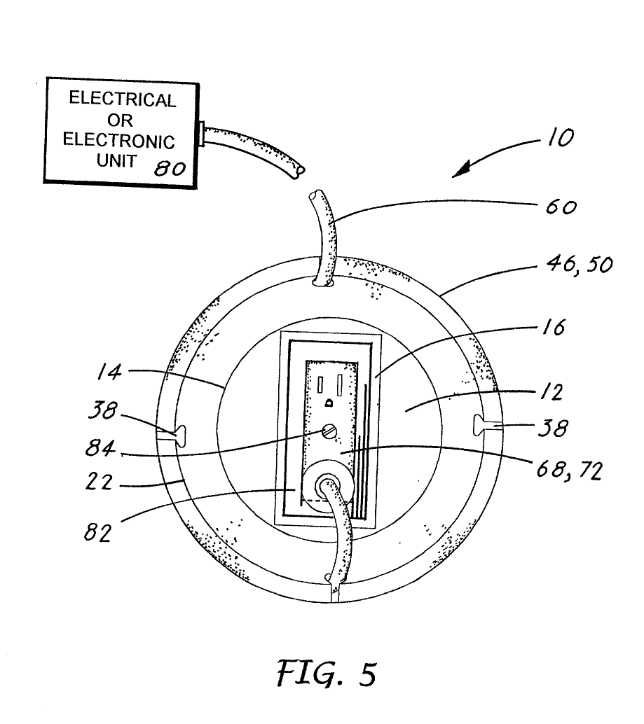

The baes 12, as shown in FIGS. 1, 2 and 3, has an outer perimeter edge 14 and a substantially centered opening 16. The opening, as best shown in FIG. 2, is dimensioned to substantially enclose the electrical receptacle 68 which can consist of a duplex receptacle 70, as shown in FIG. 1, or a flush-mounted receptacle 72 as shown in FIG. 2. The base 12 also includes a means 18 for attaching the electrical receptacle 68 to the base 12. The preferred attachment means 18 is by having the base 12 include a set of bores 20 that are in alignment with a set of receptacle mounting bores 74 located on a set of mounting tabs 76 projecting from the electrical receptacle 68 as shown in FIG. 2. When a threaded bolt 84, as shown in FIGS. 1 and 5, is inserted into the respective bores 20, 74 and threaded into a junction box (not shown) located within a wall structure the electrical-cord retainer is attached. To complete the attachment of the electrical-cord retainer 10, the wallplate is placed over the electrical receptacle 68. The wallplate is attached by inserting a threaded bolt through a center bore on the wallplate and into a centered threaded bore on the electrical receptacle 68.

Integral to the base 12 is a perimeter channel 22, as shown in FIGS. 1-5. The perimeter channel 22 has an inner edge 24 that is molded integral with the outer perimeter edge 14 of the base 12, an upper center section 26 and a downward extending outer edge 32 that terminates above the outer perimeter edge 14 of the base 12. As best shown in FIG. 1, the area encompassing the outer perimeter edge 14 of the base and the inner edge 24 of the perimeter channel forms an inner extending cavity 34. The cavity 34 is dimensioned to allow the electrical receptacle 68 and an attached wallplate 82 to be located within the confines of the cavity 34.

The perimeter channel 22 can be designed with an upper center section 26 having a radiused surface 28 as shown in FIG. 3. Optionally, the upper center section 26 can be designed to have a substantially flat surface 30 as shown in FIG. 4.

The perimeter channel 22, as shown in FIGS. 1 and 5 also incorporates at least one cord retaining slot 38. Preferably the channel 22 incorporates a plurality of slots 38 which can be located in a random pattern around the surface of the perimeter channel. For practical and aesthetic purposes the preferred count of cord retaining slots 38 is four. The four slots 38 are preferably located at 0°, 0°, 180° and 270° as measured from a vertical line taken across the middle of the retainer 10.

The boundary 44 of the perimeter channel 22 can be configured in a number of geometric shapes 46. Two of the preferred shapes is a rectangle 48, as shown in FIG. 1 or a circle 50, as shown in FIG. 5. The circular electrical-cord retainer 10 is particularly suited for industrial use. The industrial use utilizes a retainer having an outside diameter of approximately 10-inches (22.9 cm) which can accommodate a cord length of up to 30 feet (9 meters).

In whatever shape is utilized, the perimeter channel 22 is dimensioned to allow an excess length of the electrical cord 60, connected to an electrical or electronic unit 80, to be wrapped around the interior of the channel 22. When a practical length is reached, the electrical cord 60 is inserted into one of the cord retaining slots 38 prior to inserting the cord plug 62 or connector 66 into the electrical receptacle 68.

While the invention has been described in complete detail and pictorially shown in the accompanying drawings it is not to be limited to such details, since many changes and modifications may be made to the invention without departing from the spirit and the scope thereof. For example, the cord from an appliance or electronic equipment can be initially inserted into the perimeter channel and exit through a cord retaining slot, or the cord can initially be inserted into a first slot, then into the channel and exit through a second slot. Hence, it is described to cover any and all modifications and forms which may come within the language and scope of the claims.

1. An electrical-cord retainer adapted to be used in combination with an electrical cord and an electrical receptacle, said retainer comprising a base surrounded by a perimeter channel, wherein said base having means for receiving and attaching the electrical receptacle and said perimeter channel having at least one cord retaining slot and is dimensioned to allow an excess length of the electrical cord to be wrapped around the interior of said perimeter channel until a practical length of electrical cord is reached, at which time the electrical cord is inserted into one of said cord retaining slots prior to connecting the electrical cord to the electrical receptacle.

2. The retainer as specified in claim 1 wherein said means for attaching the electrical receptacle to said base comprises said base having a substantially centered opening dimensioned to receive the electrical receptacle, wherein said base having a set of bores in alignment with a set of receptacle mounting bores located on a set of mounting tabs attached to the electrical receptacle, wherein when a bolt is inserted into the two bolt bores the electrical receptacle is attached to said base.

3. The retainer as specified in claim 2 wherein said at least one cord retaining slot consists of a plurality of slots located in a random pattern around said perimeter channel.

4. The retainer as specified in claim 3 wherein the random pattern is comprised of four cord retaining slots located at 0°, 90°, 180° and 270°.

5. An electrical-cord retainer adapted for use in combination with an electrical cord and an electrical receptacle, said retainer comprising:
a) a base having an outer perimeter edge, a substantially centered opening dimensioned to enclose the electrical receptacle, and a means for attaching the electrical receptacle to said base,
b) a perimeter channel having an inner edge integral with the outer perimeter edge of said base, an upper center section, and a downward extending outer edge that terminates above the outer perimeter edge of said base, wherein the area encompassing the outer perimeter edge of said base and the inner edge of said perimeter channel forms an inward-extending cavity, and
c) at least one cord retaining slot having a center first perimeter section located on the upper section of said channel, and a second contiguous section extending downward and terminating along the outer edge of said perimeter channel, wherein said channel is dimensioned to allow an excess length of the electrical cord, connected to an electrical or an electronic unit, to be wrapped around the interior of said channel when a practical length is reached, the electrical cord is inserted into one of the cord retaining slots prior to being connected to the electrical receptacle.

6. The retainer as specified in claim 5 wherein said retainer is integrally molded of plastic.

7. The retainer as specified in claim 5 wherein said electrical cord comprises an electrical utility power cord having an end that terminates with a utility power plug.

8. The retainer as specified in claim 5 wherein said electrical cord comprises an electronic equipment cord having an end that terminates with an electronic equipment connector.

9. The retainer as specified in claim 5 wherein the boundary of said perimeter channel is configured in a geometric shape.

10. The retainer a specified in claim 9 wherein the geometric shape of said channel boundary is a rectangle.

11. The retainer as specified in claim 9 wherein the geometric shape of said channel boundary is a circle.

12. The retainer as specified in claim 5 wherein the centered opening on said base is dimensioned to accept and attach, by an attachment means, a utility-power duplex receptacle or flush-mount receptacle, wherein when attached the outer surface of the receptacle is located within the downward-extending cavity.

13. The retainer as specified in claim 12 wherein said means for attaching the electrical receptacle comprises, said base further having a set of bores in alignment with a set of receptacle mounting bores located on a set of mounting tabs attached to the electrical receptacle, wherein when a threaded bolt is inserted into the respective bores and threaded into a junction box located within a wall structure, said retainer is attached.

14. The retainer as specified in claim 5 wherein the upper center section of said channel is radiused.

15. The retainer as specified in claim 5 wherein the upper center section of said channel is substantially flat.

16. The retainer as specified in claim 5 wherein said at least one cord retaining slot is comprised of four slots located a 0°, 90°, 180°and 270°.

17. The retainer as specified in claim 5 wherein said cavity is dimensioned to accept the attachment of a wallplate peculiar to the type of receptacle being used.
